(19) United States
(12) Patent Application Publication
(10) Pub. No.: US 2009/0032474 A1
(43) Pub. Date: Feb. 5, 2009

(54) Irrigation Control System

(76) Inventor: Lance Jubelt, Grover Beach, CA (US)

Correspondence Address: LEWIS, BRISBOIS, BISGAARD & SMITH LLP, 221 NORTH FIGUEROA STREET, SUITE 1200, LOS ANGELES, CA, 90012, US

(21) Appl. No.: 11/832,422

(22) Filed: Aug. 1, 2007

(51) Int. Cl. C02F 1/66

(52) U.S. Cl. 210/743; 210/85

(57) ABSTRACT

A method for achieving the optimum pH of the water used for irrigation, comprising passing water through a water meter or a pH monitor, which transmits a signal based on the volume of flow of the water or the pH of the water, a pump which receives a signal from the water meter or pH monitor and injects a predetermined amount of an acidic compound into the irrigation water based upon the volume of flow of the water or the pH of the water.

### FIELD OF THE INVENTION

This invention comprises a method for monitoring and controlling the irrigation of residential, commercial and agricultural properties.

### BACKGROUND OF THE INVENTION

Due to the high cost of water and due to an ever dwindling supply of water, it would be beneficial to control the amount of water needed to water the landscaping for residential, commercial and agricultural fields. It would also be beneficial to control certain elements in the soil to achieve the maximum irrigation with the least amount of water.

The soil in many geographical areas is very alkaline. This is due to the presence of lime in the soil. Often carbonates and bicarbonates in the soil attach to calcium, creating an impermeable surface, where the water simply flows over the top and is not absorbed into the ground. A method is needed to increase the permeability of the soil. The more permeable the soil, the less water it takes to feed the vegetation. These lime, carbonate and bicarbonate compounds, and the like, are quite alkaline and need the presence of a certain amount of an acid to offset their negative effect.

Almost all irrigation water contains dissolved salts. Some are beneficial, such as calcium, magnesium, sulfate, and nitrate. Others, such as sodium, chloride, and boron are potentially toxic salt ingredients that must be carefully managed or avoided if possible. The third group, which interacts with and is usually present with the above salts, consists of carbonates, bicarbonates, and silicates.

The presence of these salts in both irrigation water and soil can cause destruction of soil structure and precipitation of insoluble salts in irrigation equipment. Often the most troublesome of the salt components found in or added to irrigation water is the carbonate-bicarbonate complex and phosphates and their resulting precipitates.

Conversely, low salt irrigation sources may also pose problems because the absence of salts such as calcium can also cause soils to seal. For these reasons, it is beneficial for surface and sprinkler irrigation water to be treated to lower the pH and reduce the problems associated with water containing bicarbonates.

### SUMMARY OF THE INVENTION

This invention provides a method to improve the water quality of residential or commercial landscaping, or an agricultural farm, where many acres of land are being farmed.

The inventive method for residential and commercial landscaping, such as a private home with a garden, lawn or other relatively small area of landscaping, comprises the use of a water meter with an output signal. The water meter measures the flow of water going to the landscaping. This water flow is pre-set for each area of the landscaping, as the system cycles through watering various portions of the landscaping, each area needing a different amount of water, depending upon the size of the area and nature of the vegetation growing there.

The electrical output of the water meter, the signal, is sent to a variable speed chemical pump which feeds an acidic compound into the water line, providing enough acid to keep the pH of the water between 6 and 7, the ideal pH for absorption of the water into the soil. The amount of acidic compound that is needed is determined by taking samples of the water in the water line and determining the amount of chemical needed, based upon the amount of water flowing, the quality (alkalinity) of the water and the alkalinity of the soil. From this information, the amount of acidic chemical needed to reach a desired pH of between 6 and 7 is determined. The chemical pump is then set to add the correct amount of chemical to the water flowing to the landscaping system.

For agricultural needs, where a much larger area is being watered, a pH meter is added to the system to continuously monitor the actual pH level of the water going to the soil so that it can be continuously adjusted.

Adding an acidic compound reduces bicarbonates to avoid alkalinity, poor soil structure and low fertility. It also increases water use efficiency as a result of better infiltration through the growing season, i.e., fewer, deeper and more thorough irrigations. It also solubilizes micronutrients that are unavailable due to high soil pH, and makes them available to the turf.

An acidic compound, added to irrigation water, can control destructive dissolved salts and bicarbonates that are harmful to turf. An acidic compound also destroys soil sealing alkalinity, liberates “tied-up” calcium and magnesium, eliminates induced sodium soil sealing, opens soil profile and achieves more efficient water use, that is less water used for the same result.

### BRIEF DESCRIPTION OF THE DRAWINGS

FIG. 1 is a block diagram of the watering system for a residential or commercial property;

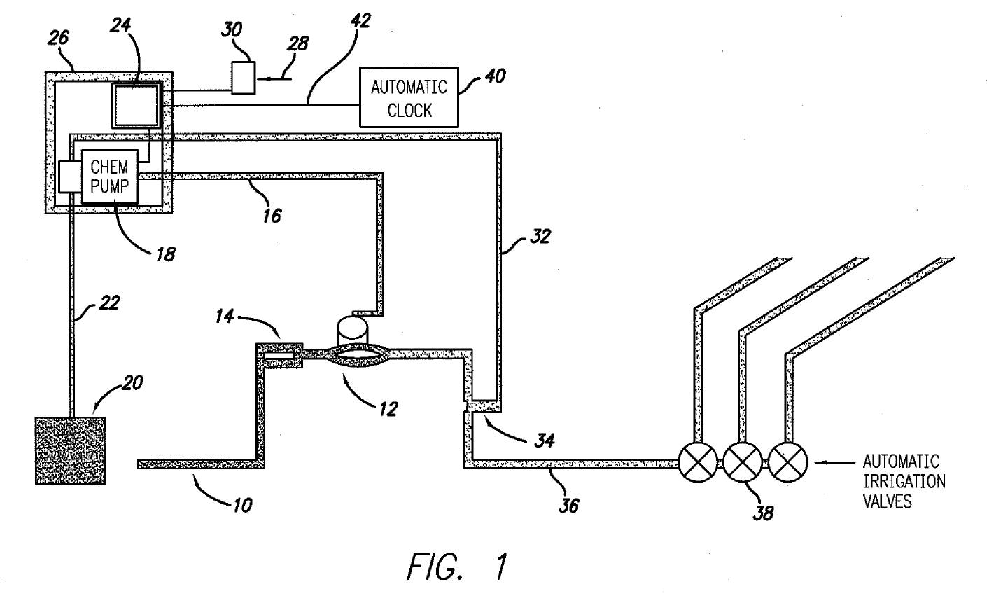

FIG. 2 is a block diagram of a watering system for large agricultural use.

### DETAILED DESCRIPTION OF THE INVENTION

Referring now to the drawings, there is shown a water main 10 which passes through a water meter 12, which has an output signal of the flow of water. A backflow valve 14 prevents any chemical from flowing back into the water system source.

An output signal 16 is sent to a chemical pump 18. The output signal 16 tells the chemical pump 18 how much water is flowing to the irrigation system. Chemical pump 18 is a dosing pump with output control based upon testing the alkalinity of the water and the soil. Chemical dosing pump 18 is programmed to deliver the proper amount of acidic compound, based upon the alkalinity tests.

A chemical storage tank 20 delivers the acidic chemical to chemical dosing pump 18 via chemical supply line 22. Power is supplied to chemical dosing pump 18 by an electrical panel 24 in an enclosure 26 to which standard 110 volt power 28 is supplied to a 24V/110V relay 30.

Chemical is delivered to the irrigation system from chemical pump 18 through delivery line 32 to chemical injector 34 where it mixes with water in water line 36. The water with the chemical now inserted flows to a set of automatic irrigation control valves 38 which control the delivery of the water to the landscaping.

An irrigation control clock 40 with 24V power supply 42, controls the operation of irrigation control valves 38, which are programmed with timers to each turn on and off at predetermined times of day. Further periodic further testing is done to make sure that the proper amount of water and chemical is being fed to the irrigation system.

Water meter 12 operates by transmitting a signal every preset number of gallons flowing through. The preset number of gallons may be any number of gallons programmed into water meter 12 by the user. The signal from water meter 12 is sent to chemical dosing pump 18. Dosing pump 18 has a flow signal interpreter which reads the water meter 12 signal representing the flow of water passing through the system. Chemical dosing pump 18 adds (doses) an acidic substance to the water flow based on the volume of water flowing through. This makes the water irrigating the landscaping the optimum pH for maximizing absorption by the alkaline soil, thus making it possible to water the landscaping with the minimum amount of water required.

Water meter 12 is a commercially available item sold by Daniel L. Jerman Co. and others. Chemical dosing pump 18 is manufactured by Grunfos Pumps of Olathe, Kans. Various acidic compounds may be used with chemical dosing pump 18, such as “US 15” manufactured by Verdegaal Brothers of Hanford, Calif. “US 15” is a mixture of urea, sulfuric acid and water. Sulfuric acid alone can be used but is not recommended for residential and commercial landscaping.

Tests were conducted of the system described above and it was possible to change the soil and water profile as follows: The pH of the water to be used for irrigation started at approximately 7.4 and lowered to a 6.5 pH immediately upon treatment. In a twelve month study, the ground pH started at a pH level of 7.2 and changed to between a pH of 7.1 and 6.5, in various spots in the test area site.

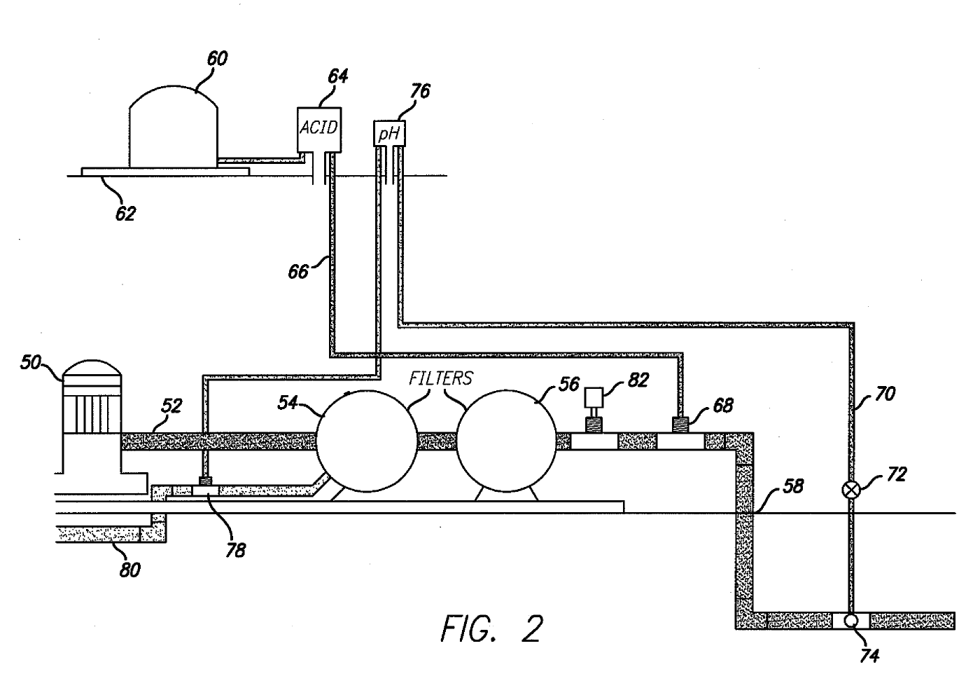

Referring now to FIG. 2, there is shown the system for agricultural use. Water for irrigation comes from a water source, such as well 50. The water passes through water line 52 and through dual filters 54 and 56. Water line 52 continues from filters 54, 56, and goes underground at point 58 passing under the fields to be irrigated, where it is sprayed through any of various types of water dispensers, such as drip and/or ground or overhead sprinklers, etc.

Acid storage tank 60 sitting on level pad 62, contains an acidic compound which is added to the water flow by a variable speed acid pump 64, to maintain a pH of between 6 and 7, for optimum absorption of the irrigation water. The acid from tank 60 passes through acid pump 64 and through acid injection line 66 to injection probe 68, which is an injection nozzle with a one-way valve, where the acid enters water line 52.

Return line 70, with valve 72, takes water at valve 74 from water line 52, downstream from acid injection probe 68. The downstream water is passed through pH monitor 76, where the pH is constantly measured. The downstream water that passes through pH monitor 76 is returned through back flush valve 78, through back flush line 80 leading to a back flush reservoir (not shown).

Pressure switch 82 is a safety shut-off valve, which shuts off the system if it senses no pressure, which means no water is flowing.

For agricultural use, sulfuric acid or citric acid is used to acidify the irrigation water, however sulfuric acid is usually not recommended for residential and commercial irrigation systems.

The pH monitoring system 76 comprises a pH sensor which measures the pH of the water, a variable speed motor to operate a pump to pull the water through the monitor and a pH monitor display, so that the pH levels can be visually be observed. The amount of acid to be added to the water line is automatically determined based on the pre-set pH level desired by the grower. The system reads the pH level and raises or lowers the acid flow in response thereto.

Having thus described the invention, I claim:

1. a method for achieving the optimum pH of water used for irrigation, comprising passing water through a water meter or a pH monitor, which transmits a signal based on the volume of flow of the water or the pH of the water, a pump which receives a signal from the water meter or pH monitor and injects a predetermined amount of an acidic compound into the irrigation water based upon the volume of flow of the water or the pH of the water.

2. The method of claim 1, for achieving the optimum pH of water used for irrigation of residential and commercial landscaping comprising, passing the irrigation water through a water meter which transmits a signal based upon the volume of flow of the water, a chemical dosing pump which receives the signal from the flow meter and doses a predetermined amount of an acidic compound into the irrigation water based upon the volume of flow of the water.

3. The method of claim 2 in which the acidic compound comprises urea, sulfuric acid and water.

4. The method of claim 2 in which sufficient acidic compound is added to the water to reach a pH of the water of between 6 and 7.

5. The method of claim 2 in which the amount of acidic compound to be added to the irrigation water is based upon pH testing of the water and the ground.

6. The method of claim 1 for achieving the optimum pH of water used for irrigation of agricultural land comprising, passing water from a water source through a water line to the agricultural land, injecting an acidic compound through an acid pump into the water line, at an injection point between the water source and the agricultural land, taking water from the water line downstream from the acidic compound injection point, and passing said water through a pH monitor to constantly measure the pH of the water, and varying the amount of acidic compound injected into the water line based upon the pH of the water determined by the pH monitor.

7. The method of claim 6 in which the acidic compound is sulfuric acid.

8. The method of claim 6 in which the acidic compound is citric acid.

9. The method of claim 6 in which the optimum pH of the irrigation water is between 6 and 7.

10. Apparatus for irrigation of agricultural land comprising an irrigation water source, a water line to carry irrigation water from the water source to the agricultural land, an acidic compound storage tank, a pump to inject a measured amount of acidic compound into the water line at an injection point, structure to take water from the water line downstream of the acid compound injection point, and pass the water through a pH monitor to constantly measure the pH of the irrigation water, structure to vary the amount of the acidic compound added to the water line in response to the pH measurement of the water.

11. The apparatus of claim 10 in which the pH monitor further comprises a pump to pull water through the monitor and a display to visually observe the pH measurements.

12. The apparatus of claim 9 further comprising a back flush line to receive water from the pH monitor.

13. The apparatus of claim 9 further comprising a pressure switch to turn off the irrigation system if no water is flowing through it.

14. Apparatus for irrigation of residential or commercial landscaping comprising an irrigation water source a water line to carry irrigation water from the water source to the landscaping, a water meter for measuring the volume of water passing through the water line, said water meter having structure to transmit a signal based upon the volume of flow of the water, a chemical dosing pump which receives the signal from the water meter, said dosing pump having structure to dose a predetermined amount of an acidic compound into the irrigation water based upon the volume of flow of the water.

15. The apparatus of claim 14 further comprising a chemical storage tank for holding the acidic compound and structure to pass acidic compound from the chemical storage tank to the dosing pump.
